(19) United States
(12) Patent Application Publication
(10) Pub. No.: US 2002/0160815 A1
(43) Pub. Date: Oct. 31, 2002

(54) Method and apparatus for adjusting a dialing sequence based on location

(76) Inventors: Milan Patel, San Marcos, CA (US); Anders Heie, Poway, CA (US); Mateera Panichkul, San Diego, CA (US); Dandi Lynde-Redman, San Diego, WY (US)

Correspondence Address: MILAN I. PATEL, NOKIA, INC., 6000 CONNECTION DRIVE, MD 1-4-755, IRVING, TX, 75039, US

(21) Appl. No.: 09/846,850

(22) Filed: Apr. 30, 2001

(51) Int. Cl. H04M 1/00

(52) U.S. Cl. 455/564; 455/404; 455/432

(57) ABSTRACT

The present invention encompasses an electronic device operated in a communication system (for example CDMA, TDMA, GSM, etc.). The electronic device comprises a method that adjusts a dialing sequence, used to initiate a call, based on the current location of the electronic device. The method adjusts the dialing sequence to add any missing information, such an area code, country code, etc., thereby allowing the user to only provide a minimum length of dialing sequence when placing a call to a called party. Also, if the dialing sequence is represents one of the emergency numbers, then the method adjust the dialing sequence to use an emergency number used within a region defined by the current location.

### FIELD OF THE INVENTION

The present invention relates to an electronic device having a calling sequence facilitator, more particularly, to a method and apparatus for adjusting a dialing sequence.

### BACKGROUND OF THE INVENTION

A communication system is operable to communicate information between a transmitting station (a calling party) and a receiving station (a called party) by way of a communication connection. A wireless communication system is a communication system in which information is communicated between the transmitting and receiving stations via one or more base stations. A cellular or digital communication system is exemplary of a multi-user wireless communication system.

Various wireless communication systems have been developed and implemented throughout large geographical areas. Various standards have been established, and the wireless communication systems are generally constructed to be operable in compliance with one or more of the standards. One such standard, referred to as IS-95/IS-2000 defines a CDMA (Code Division Multiple Access) based wireless communication system. In a wireless communication system such as CDMA, defined by IS-95/IS-2000 standard, a call is established between the called party and the calling party when the calling party initiates the call by using a calling sequence. Generally, the calling sequence comprises the user entering a subscriber's address, for example the dialing sequence (also referred to as phone number), of the called party.

In a global communication system, communication devices such as a wireless mobile terminals or land-based terminals communicate with each other via use of the dialing sequence. Generally, the dialing sequence is defined as an N-digit number, wherein the value of N varies from one country to another. For example, in the United States N is valued at 11, so that the 11-digit dialing sequence is defined as having a 1-digit country code, a 3-digit area code followed by a 3-digit sub-area code followed by a 4-digit subscriber's number (for example, 1-333-333-3333). Other countries however, may have additional digits representing a different country code (for example 358-46-444-4444 may represent Finland and 44-888-90-90-90 may represent England).

Typically, when a user activates a communication subscription for an electronic device, the service provider assigns the electronic device a subscriber's address (hereafter referred to as a phone number). The phone number is based on the geographical location where the subscription was activated. For example, if the communication subscription for a electronic device was activated in US, then the phone number would be a 11 digit phone number comprising a country code, an area code, sub-area code and subscriber's number, as described above.

When the phone companies assign the phone number, the area code and sub-area codes of the phone number are assigned based on a geographical region and the number of subscribers within that geographical region. For example, the geographical area of the United States is divided into several geographical regions, wherein each geographical region is assigned a unique area code. Each geographical region may be connected to other regions (referred to as neighboring regions) and each geographical region comprises one or more sub-regions. Each sub-region is assigned a sub-area code that is unique within its geographical region.

Generally, everything fixed within a geographical location is considered to be associated with the unique area code. This includes houses, buildings and specifically, base stations, etc. When a subscription for an electronic device is activated in a particular geographical region (the home region), the area code and sub-area code of the assigned phone number represent the area code of home region and the sub-area code of the sub-region of the home region, respectively. Upon activation of the subscription, the subscribing company also assigns a non-roaming region and a roaming region for the communication device. The non-roaming region is the geographical region defined by the home region and one or more neighboring regions. All other the geographical regions that are not part of the non-roaming regions define the roaming regions. When the mobile communication device is used outside of region defined the non-roaming region the mobile communication device is considered to be roaming.

When user of the mobile communication device desires to communication with a called party, the user (the calling party) provides the dialing sequence, representing the called party's phone number to initiate a calling sequence. The user either enters each digit of the dialing sequence or selects a dialing sequence using a menu feature. However, the user must provide a proper dialing sequence to complete the call. There are number of scenarios which influence the proper dialing sequence, such as the home area code assigned to calling party, the home area code of the called party, the location of the calling party, the dialing sequence rules for a country or geographical area, etc. For example, in the USA, the minimum number of digits required to establish a call is 7 digits, comprising a sub-area code and subscriber's address. Generally, if the home area code of the calling party is same as the called party and the calling party is located within the home region or one of the neighboring regions, then only the sub-area code and the subscriber's number are required for a proper dialing sequence. For example, if the calling party and the called party are assigned a 619 area code and the calling party is calling from a geographical area representing a 619 area code, then the calling party need not provide the area code as part of the dialing sequence. Hence, only the sub-area code and subscriber's address is required. However, if the assigned home area code of the calling party is different then the called party's home area code, then a longer dialing sequence is required, including the home area code (in some cases, the country code is also required) of the called party. This is true even if the calling party is located two feet from the called party. Also, if the calling party is roaming or is calling from another country, then full dialing sequence (for example, 11 digits for US plus any other special international dialing rules) must be provided, including home area code of the called party. This is true even if the calling party and called party have the same home area code. For example, if the user is has an electronic device, which was activated in Finland, and the user is in England, the user must provide full dialing sequence including the proper country code when calling within England. If user does not know the country code, the user may have waste time and money to determine the proper dialing sequence.

Having to provide the full dialing sequence based on location of the calling party is inconvenient and may cause more dialing errors, especially when the user has to manually enter the country code, the area code, the sub-area code and the subscriber's number. This is especially inefficient, when user is located in the same geographical area of the called party or is calling a called party with same home area code from a different geographical area. Furthermore, the phone companies are constantly adding and dividing area codes to accommodate for the growth in the number of subscribers. Requiring the user to know dialing rules and area codes within an unfamiliar geographical area causes unwanted dialing errors, especially when the country code and/or the area code of a particular geographical area change due to increase in subscriptions.

It would be useful if the communication device can adjust a user provided dialing sequence to use a proper dialing sequence based on the location of the communication device.

### SUMMARY OF THE INVENTION

The present invention advantageously provides an apparatus and an associated method, for an electronic device to modify or adjust a user provided dialing sequence based on the location of the communication device.

The present invention encompasses an electronic device, such as a mobile terminal, a personal digital assistant (PDA) or a computer, which may be operated in a communication system (for example CDMA, TDMA, GSM, etc.). The electronic device comprises a method that adjusts a dialing sequence, part of a calling sequence to make a call to a called party, based on the current location of the electronic device. The method advantageously adjusts the dialing sequence to add any missing information, thereby allowing the user to only provide a minimum length of dialing sequence when placing a call to a called party. The missing information is calculated based on the location of the calling party and the dialing sequence. For example, in the USA, the phone companies require minimum of seven digits as a valid dialing sequence. The method categorizes the location of the electronic device (also referred to as location of calling party) when the user attempts to make a call to properly adjust the dialing sequence or to provide a user with options on correcting the dialing sequence. For example, if the electronic device (including a SIM card) is assigned 555 area code and is located in a region defined by 777 when placing a call, then the user may be prompted to use the 555 area code or the 777 area code. If the user is calling back to the 555 area code, then user may select the appropriate option. However, if the user wishes to call a local establishment, the user is provided with an area code assigned to the current region, for example 777. Thereby, not requiring the user to know the area code of unfamiliar regions. Also, if the 777 area code is considered as the neighboring area code to the 555 area code, then the dialing sequence may be further evaluated to determine if the dialing sequence represent a number from the 555 area code or the 777 area code. The method may also generate a list of missing information, such as one or more neighboring area codes associated with the current location, or one or more neighboring area codes associated with the home region.

Additionally, the dialing sequence may be adjusted automatically based on the type dialing sequence and/or the user's selected preferences, such as emergency numbers. For example, if the method detects that the dialing sequence is an emergency number, such 911 for US, then the method advantageously adjust the dialing sequence to use an emergency number used by the current region. This especially advantageous for the “world phones”, that may be used in more than one country. For example, a user of the electronic device is allowed to enter 911 for an emergency while using the electronic device in Europe, even though in Europe, a 112 dialing sequence is used for emergency calls. The method automatically adjusts this dialing sequence so the user is not required to know the emergency numbers in an unfamiliar geographical region.

A more complete appreciation of all the advantages and scope of the present invention can be obtained from the accompanying drawings, the following detailed description of the invention, and the appended claims.

### BRIEF DESCRIPTION OF THE DRAWINGS

FIG. 1 illustrates a block diagram of a mobile terminal into which an embodiment of the invention may be implemented;

FIG. 2 shows a communication system in which the mobile terminal receives the base station information;

FIG. 3A shows an area code table depiction of an embodiment of the invention;

FIG. 3B shows a dialing sequence rules table depiction of an embodiment of the invention;

FIG. 4 shows a dialing sequence adjustment task software module depiction of an embodiment of the invention.

FIG. 5 shows an evaluate dialing sequence task software module depiction of an embodiment of the invention;

FIG. 6 shows a Location categorization task software module depiction of an embodiment of the invention;

FIG. 7 shows an area code determination task software module depiction of an embodiment of the invention; and

FIG. 8 shows a lookup adjustment action task software module depiction of an embodiment of the invention.

### DETAILED DESCRIPTION OF THE INVENTION:

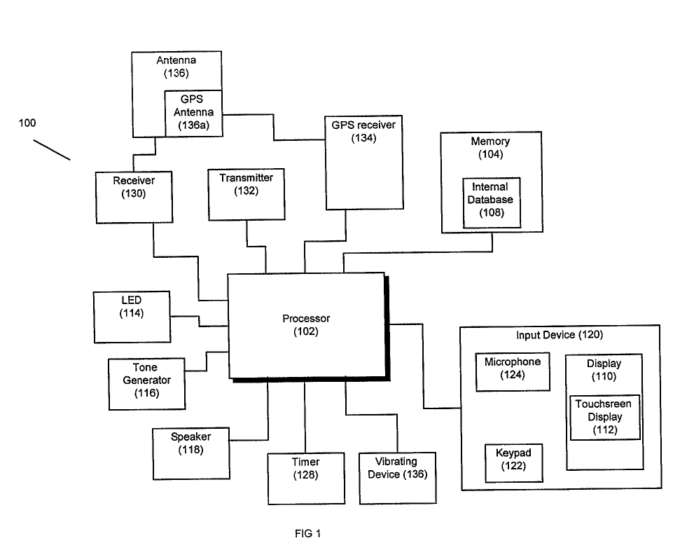

FIG. 1 is a block diagram of the electronic device, such as a mobile terminal 100, according to an embodiment of the invention. Generally, the mobile terminal 100 includes a controller 102 (which may also be known as a processor 102) coupled to various memories, collectively shown as memory 104. Memory 104 includes a plurality of stored constants and variables that are used by processor 102 during the operation of the electronic device 100. For example, memory 104 stores the values of the various feature parameters and the Number Assignment Module (NAM). The memory 104 is also holds various parameters such as an assigned home country code, an assigned home area code and assigned list of neighboring area codes. The memory 104 also comprises an internal database 108, for storing necessary parameters for carrying out the invention. An operating program for controlling the operation of processor 102 is also stored in memory 104 (typically in a read only memory). Memory 104 is also used to store data provided by the user through the user interface. Furthermore, memory 104 is used to hold the subprograms or sub-processes for controlling the operation of mobile terminal 100 and carrying out the embodiment of the invention. The operating program in memory 104 includes routines for adjusting the user provided dialing sequence when establishing a call.

The user interface of the mobile terminal 100 also includes a Liquid Crystal Display (LCD) 110, a touch-screen display 112, Light Emitting Diode (LED) 114, tone generator 116, speaker 118 and user input device 120, comprising alpha-numeric keypad 122, all of which are coupled to processor 102. The input device 120 may also comprise microphone 124, for generating input, and the touch screen display 112. Mobile terminal 100 also comprises timer 128 (also referred to as a clock chip) coupled to processor 102 for synchronizing the operations of processor 102 and tracking time.

The exemplary mobile terminal 100 also includes a receiver 130 coupled to an antenna 136 for receiving incoming signals, and a transmitter 132 for transmitting outgoing signals, both are coupled to the processor 102. The processor 102, coupled to the transmitter 132 and the receiver 130, initiates the transmission of outgoing signals and processes incoming signals, respectively. These signals may include signaling information in accordance with the air interface of the applicable cellular or digital system and also user speech and/or user generated data. The outgoing signals may be used to request data from external databases and the incoming signals may include data presenting phone information comprising country code and area code information from one or more base stations.

In an embodiment, the mobile terminal 100 comprises a Global Positioning System (GPS) receiver 134 for receiving GPS signals from one or more navigational satellites. The GPS receiver 134 is coupled to the processor 102, the processor 102 for processing GPS signals to calculate the location of the mobile terminal 100. The GPS signals are transmitted to the surface by orbiting GPS satellites (preferably three or more), that are picked up by a GPS antenna 136a, which may be integrated into the antenna 136. The GPS receiver 134 converts the GPS signals received from the GPS orbiting satellites into the spatial coordinates of the current receiver location. The spatial coordinates may be defined by the four coordinates x, y, z and t, with x, y, z being the three dimensional spatial point and t being the time at which the x, y, z spatial reference occurs. By simple geometry, for example triangulation, the location of the mobile terminal 100 having a GPS receiver 134 can be calculated. The use of triangulation to determine position is well known and one of ordinary skill in the art will recognize that use of GPS signals will produce a very accurate fix on the GPS receiver's 134 location. Using the spatial coordinates determined from base stations or GPS satellites and using well-known triangulation techniques the processor 102 is able to generate the location (or position) of the mobile terminal 100.

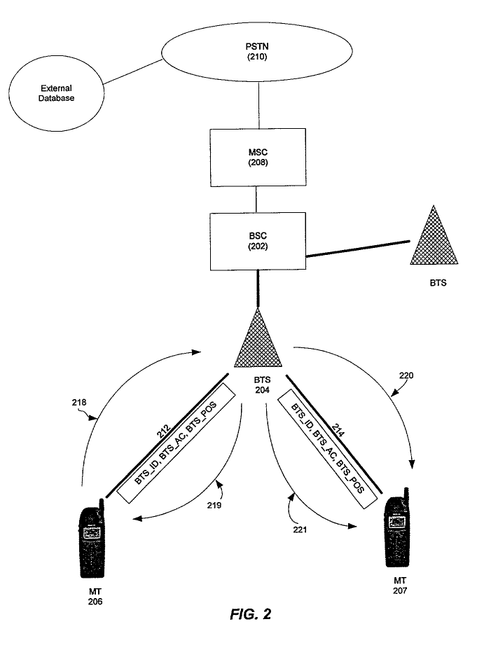

FIG. 2 shows an exemplary communication system 200. The communication system comprises a Base Station Controller (BSC) 202, which control a number of Base Transceiver Stations (BTS) 204. One or more Mobile Terminals (MT) 206 and 207, analogous to mobile terminal 100, are connected via a radio communication channel. The BSCs 202 are connected to a Mobile Switching Controller (MSC) 208, which typically include the interface and processing circuitry for providing system, control to the BSCs and BTSs. The MSC 208, also controls the routing of a telephone calls from the MT 206 and 207 to other terminals via the Public Switched Telephone Network (PSTN) 210. Also, the MT 206 and 207 may access external database 216 via the BTS, which in turn uses the BSC 202, the MSC 208 and PSTN 210 to access the database 216.

The BTS 204, generally provides a coverage based on geographical location wherein one or mobile terminals 206 and 207 may be connected to the BTS via a MT-BTS communication link 212 and 214. An exemplary method of establishing the communication link between a MT and a BTS is defined in the IS-95/IS-2000 standard. Each time a mobile terminal enters a geographical area covered by a BTS, the MT and the BTS attempt to establishes a communication link between the MT and BTS using communication signals 218, 219, 220 and 221 which are generally defined in the IS-95/IS-2000 standard for CDMA. This process is known as the acquisition process. In the CDMA environment, the mobile terminals 206 or 207 are connected (having a communication link) to only one BTS at time via the communication link 212 or 214. However, the mobile terminal may communicate with another base stations to switch the communication link from on base station to another. This process is known as the handoff. Once a communication link is established, either by acquisition or handoff, the BTS sends the BTS information to the mobile terminal 100, which is stored in the memory 104 of the mobile terminal 100.

In a solution in accordance with the invention, the BTS (herein referred to as base station) 204 provides information, such as a base station id (BTS_ID), an assigned an area code (BTS_AC) and/or position (BTS_POS) of the base station 204 to all the connected mobile terminals 206 and 207. The base station 204 may also provide a country code as part of the base station 204 information. In an embodiment of the invention, upon the mobile terminals 206 and 207 being connected to the base station 204, via the communication link 212 and 214, the base station information is received at the mobile terminals 206 and 207.

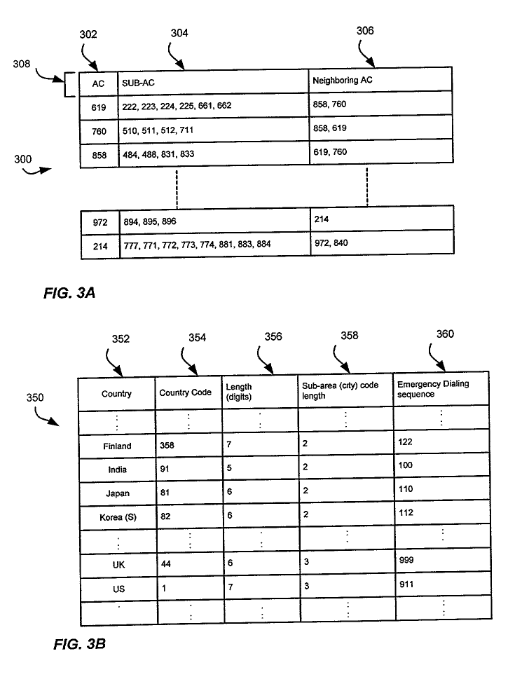

FIG. 3A and FIG. 3B shows exemplary tables, an area code table 300 and a dialing sequence rules table 350, which are stored in a database. In preferred embodiment, the tables 300 and 350 are stored in an internal database 108, generally defined in the memory 104 of the mobile terminal 100 for fast access. Optionally, these tables 300 and 350 may be stored in an external database, such as the databases of the BTS 204, BSC 202 or MSC 208. These tables may be retrieved automatically or upon the user's request from the external databases. The tables may be periodically updated, during an acquisition process or during a handoff process. Alternatively, the area code table 300 may be modified by the user using menu functions or by connecting the mobile terminal 100 to a general-purpose computer. Various other techniques may be used to modify and update tables 300 or 350, without departing from the invention. It should be noted that the tables might be partitioned or compressed to conserve memory space or to increase access time.

As shown in FIG. 3, the exemplary area code table comprises an area code column 302, a sub-area code column 304 and a neighboring area code column 306. The area code column 302 contains entries, which represent the area code of a particular geographical region, for example the USA. The sub-area code column 304, contain entries which represent the sub-area codes which are associated with an area code listed in the area code column 302. The neighboring area code column 306 contains entries, which represent a list of neighboring area codes that are associated with the area code listed in the area code column 302. Each row of the area code table 300 represents an area code of a particular geographical region, a list of sub-area codes associate with the area code and a list of neighboring area codes associated with the area code. For example, the row 308 of the area code table 300, represents an “619” area code with “222, 223, 224, 225, 661, 662” as the sub area codes and “858, 760” as the neighbor area codes. Generally, the content of area code table is determined by the local phone companies and is modified periodically based on number of subscribers.

FIG. 3B shows an exemplary dialing sequence rules table 350. The dialing sequence rules table 350 contains entries, which are indexed by rows and columns. The rows represent countries of the world and the columns represent the type of rules associated with each country. In the exemplary table 350, a country column 352, a country code column 354, a length column 356, a sub-area code length 358 and an emergency dialing sequence column 360 is provided for each row. The country column 352 represents the name of a country. The country code column 354 represents the country code of the country. The length column 356 represents a minimum length of digits required of a standard dialing sequence. The sub-area (city) code length column 358 represents the length of the city area code (ie, the number digits which represent the city code). The emergency dialing sequence column 360 represents the dialing sequence used in the country to make an emergency call. In some countries, an emergency dialing sequence may be not defined a “0” is used to make the emergency call.

In an exemplary implementation of the embodiment, upon activation of a wireless communication subscription, the home country code, the home area code and the list of neighboring codes are stored into the memory 104. Generally, the home country code represents the country (referred to as home country) where the subscription was activated. The home area code represent the region (referred to as home region) where the subscription was activated and list neighboring codes represent the regions (referred to as neighbor regions) which are generally adjacent to the home region. Upon the user providing a dialing sequence (phone number) using the input device 120, the processor 102 determines if the dialing sequence requires any adjustment based on the location of the mobile terminal 100. The processor 102 determines the area code of the current region and checks the area code assigned to the mobile terminal 102. If the area codes match then the dialing sequence is not adjusted. However, if the area codes do not match, for example when the mobile terminal is outside of a home region, then processor 102 allows the to user to adjust the dialing sequence to use the proper area code. If the user is using the mobile terminal in another country and if the dialing sequence is an emergency number, then the processor adjust the dialing sequence to use the current location emergency number associated with the current region (country), shown in FIG. 3B. This method allows the user to simply dial a familiar emergency number even when traveling from one country to another without having to know the emergency numbers for each country.

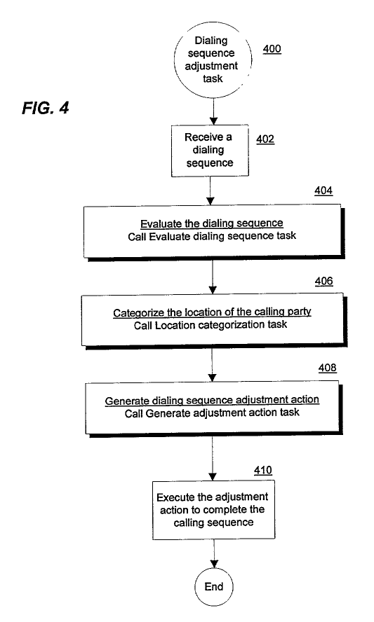

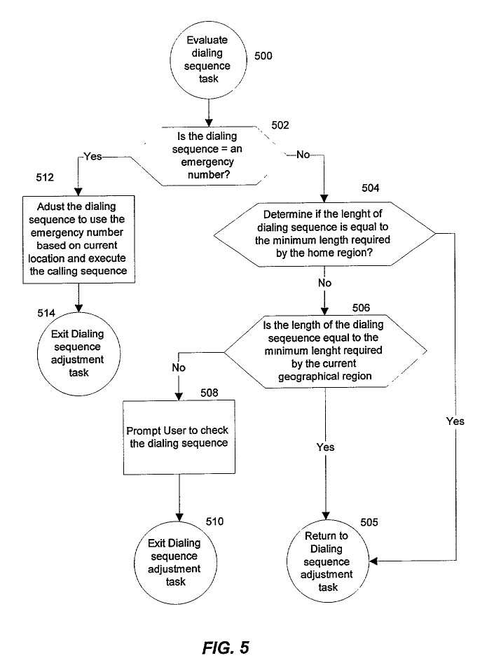

Referring now to FIG. 4, which describes a dialing sequence adjustment task 400 accordance to an embodiment of the invention for adjusting the dialing sequence. The dialing sequence adjustment task 400 is initiated upon the user accepting a desired dialing sequence when the dialing sequence adjustment feature is activated. The user using a menu feature of the mobile terminal 100 may activate/deactivate the use of the dialing sequence adjustment task 400. At block 402, a standard dialing sequence is received. The standard dialing sequence is defined such that each digit of the dialing sequence represents a number from zero to nine. In the preferred embodiment, at block 402, only a standard dialing sequence is evaluated for adjustment. Dialing sequences that contain special characters, such as +, *, #, etc., are processed before or after executing the dialing sequence adjustment task 400. For example, a “+5553333” dialing sequence may be processed as “5553333” by the dialing sequence adjustment task 400 and “+” character may be processed after the dialing sequence adjustment task 400 has processed the “5553333” dialing sequence. At block 404, the processor 102 evaluates the received standard dialing sequence. The dialing sequence is evaluated to determine if the dialing sequence is an emergency number. As it is described in FIG. 5, if the dialing sequence is an emergency number, then call is established accordingly and the dialing sequence adjustment task 400 is terminated. Generally, the dialing sequence is evaluated to determine if the length of the dialing sequence is equal to a minimum length based on current geographical region rules or home region rules. If not, then the user may be prompted and the dialing sequence adjustment task 400 is terminated. At block 406, the processor 102 evaluates the location of the mobile terminal to categorize the location of the calling party. Generally, the processor 102 determines if the calling party is within the home region, the neighboring region or the roaming region. Based on the location of the calling party, at block 408, the processor 102 generates a dialing sequence adjustment action to adjust the dialing sequence if the dialing sequence requires any adjustments. At block 410, the processor 102 executes the generated adjustment action to complete the calling sequence.

FIG. 5 illustrates an evaluate dialing sequence task 500 accordance to an embodiment of the invention to evaluate the received dialing sequence. The evaluate dialing sequence task 500 evaluates the received dialing sequence to determine if the dialing sequence needs to be adjusted. At block 502, the processor 102 determines if the dialing sequence represents an emergency number. The processor 102 accesses an internal database, for example the table 350 shown in FIG. 3B, containing a list of all possible emergency numbers that are used globally (column 360 of table 350), to determine if the dialing sequence is in the list of emergency numbers. If the dialing sequence is not in the list of emergency numbers then the processor 102 determines that the dialing sequence does not represent an emergency number. At block 504, the processor 102 determines if the length of the received dialing sequence equals the minimum length required by the home region. In the preferred embodiment, the processor 102 evaluates the minimum required length for a dialing sequence for a home region pre-stored in the internal database against the received dialing sequence. If determined that the received dialing sequence is equal to the minimum length required by the home region, then at block 505, the processor 102 returns to the dialing sequence adjustment task 400 for further processing. Otherwise, at block 506, the processor 102 determines if the dialing sequence is equal to the minimum length required by the current geographical region. In the preferred embodiment, the processor 102 access a database to determine the current country code and the minimum dialing sequence length associated with that country code. Preferably, the processor 102 accesses an internal database, which is updated with base station information, including the country code, upon connecting to a base station 204. It should be noted that an external database might be accessed without departing from the invention. Also, the processor 102 may use the position calculation techniques to determine the country code and dialing rules associated with the current location and update the internal database prior to accessing the database. Also, the user may manually update the internal database by entering country code upon entering the country. If determined that the length dialing sequence is in accordance with minimum length requirements of the current geographical location, then at block 505, the processor 102 returns to the dialing sequence adjustment task for further processing. Otherwise, at block 508, the user is prompted to check the dialing sequence and at block 510, the dialing sequence adjustment task is terminated so that user may use the dialing sequence or fix it.

Referring back to block 502, if the dialing sequence represents an emergency number, then at block 512, the processor adjusts the dialing sequence to use a emergency number based on current location and executes the calling sequence. In the preferred embodiment, the processor 102 access the internal database 108 to determine the country code associated with the current location. In an the preferred embodiment, the processor receives the country code from the base station 204 to which the mobile terminal has a communication link, for example 212. The base station 204 provides the country code upon the mobile terminal 100 connecting to the base station 204, which may be stored in the internal database 108. Also, the current country code may be determined by calculating the mobile terminal's 100 position if the country code is not available via the base station 204. For example, using GPS receiver 134 and position calculating techniques to first determine the latitude and the longitude value for the mobile terminal 100. Then accessing a table (not shown), stored in database that associates all the values of latitude and longitude to a country code, to determine the country code associated with the determined latitude and longitude and storing country code in the internal database 108 prior to the making a call. In another embodiment of the invention, if the user of the mobile terminal knows the country code, the user may provide the country code by using the input device 112. Upon the processor 102 determining the country code, the processor 102 access the emergency dialing sequence column 360 of the dialing sequence rule table 350 to determine the proper emergency dialing sequence associated the current country code. The processor 102 then adjusts the dialing sequence to use a proper emergency number (also referred to as a current location emergency number) and executes the calling sequence. At block 514, the processor 102 terminates the dialing sequence adjustment task.

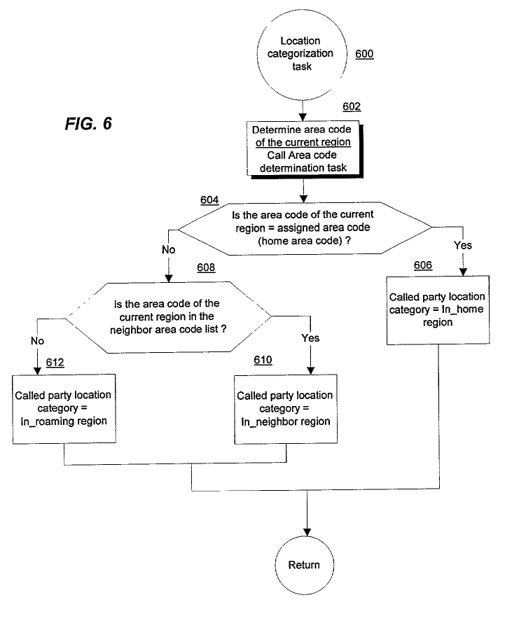

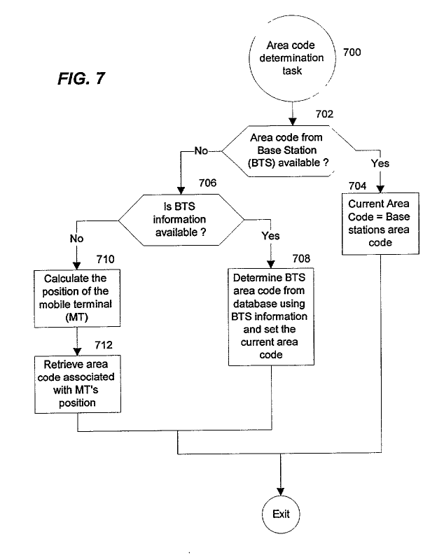

FIG. 6 illustrates a Location categorization task 600 accordance to an embodiment of the invention. This task is initiated to categorize the location of the calling party. At block 602, the processor 102 executes an area code determination task shown in FIG. 7, to determine a current area code of a region (referred herein as current region) associated with the current location of the mobile terminal 100. Upon determining the current area code, the processor 102 evaluates the current area code to determine a location category. In an embodiment of the invention, location category comprises an In home region category, an In_neighbor region category or an In_roaming region category. At block 604, the processor determines if the area code of the current region is equal to the area code assigned to the mobile terminal 100 as the home area code. If yes, then at block 606, the processor 102 sets the location category to represent in home region (In_home region category), whereby the calling party is considered to be located in the home region. Otherwise, at block 608, the processor 102 determines if the area code of the current region is in a list of neighboring area codes associated with the home area code. The neighboring list is stored in the memory 104 and may be periodically updated by the user or by the network. If the current area code is the list of neighboring area codes, then at block 610, the processor 102 sets the location category to represent in neighbor region (In_neighbor region category), whereby the calling party is considered to be located within one of the assigned neighboring regions. Otherwise, at block 612, the processor 102 sets the location category to represent in roaming region (In_roaming region category), whereby the calling party is considered to be roaming and out of home or neighbor region.

FIG. 7 illustrates an area code determination task 700 accordance to an embodiment of the invention. The area code determination task 700 is used to determine a area code assigned for a region associated with a location of mobile terminal 100. The area code determination task 700 is initiated by the Location categorization task 600 to determine the area code of the current region. At block 702, the processor 102 determines if the area code of the base station 204, which the mobile terminal 100 is connected to, is available. With the evolution of the base stations, it is expected that all the base stations provide an area code as part of the acquisition process. In a preferred embodiment the area code of the base station 204 is received from the base station 204 upon establishing a communication link between the base station 204 and the mobile terminal 100. Upon completing the acquisition process and establishing a communication link between the mobile terminal 100 and the base station 204, the base station 204 transmits the base station information to the mobile station 100. Thereafter, the mobile terminal 100 stores the base station information into the memory 104 of the mobile terminal 100. Depending on the type of service and the evolution of the base stations, the area code of the base stations may not be included in the base station information. If the area code of the base station 204 is available, then at block 704, the area code of the current region is set to the base station's 204 area code. Otherwise, at block 706, the processor 102 determines if any base station any base station information is available. If the information is available, then at block 708, the processor 102 calculates the current area code by determining the area code of the base station 204 by using the base station information. In an embodiment, the base station information comprises a base station identification, wherein the mobile terminal 100 uses a database and the base station ID to retrieve the area code associated with the base station 204. The base station database may be internal to mobile terminal 100 or external which may be accessed using well-known internal protocols. The base station database may be retrieved upon a request by the user or updated periodically. In an embodiment of the invention, the current area code may also be displayed on the display for future use. Referring back to block 706, if the base station information is not available, then at block 710, the processor 102 determines the position of the mobile terminal 100. Various well-known location determination techniques may be used to determine the location of the mobile terminal 100. In the preferred embodiment of calculating position of the mobile terminal 100, a GPS receiver is provided. Using well-known location calculating methods, the processor determines the position of the mobile terminal 100. The position may be calculated in latitude and longitude coordinates. Upon determining the position of the mobile terminal 100, at block 712, the processor 102 access an area code database to retrieve area code associated with the current position (in latitude and longitude). The retrieved area code is then set and stored as the current area code of the current region.

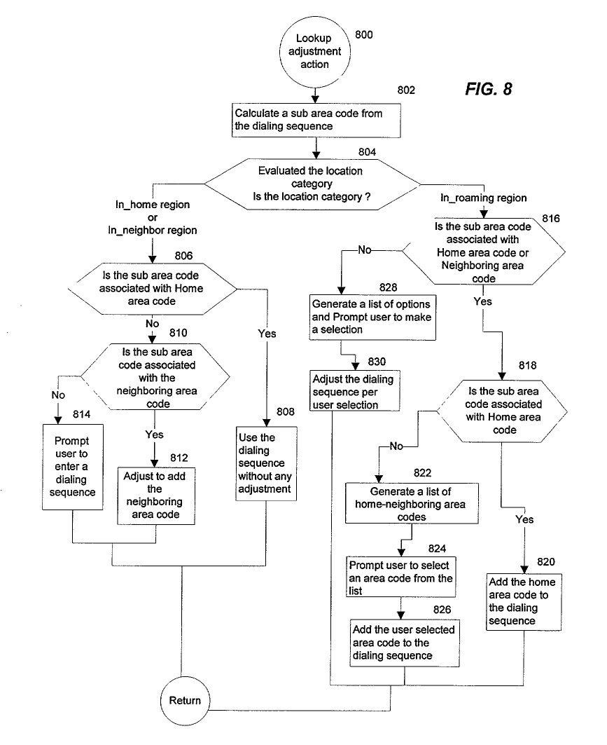

FIG. 8 illustrates a lookup adjustment action task 800 accordance to an embodiment of the invention. The lookup adjustment action task 800 is initiated by the dialing sequence task 400 upon categorizing the location of the calling party. At block 802, the processor 102 extracts a sub-area code from the dialing sequence. As a general rule and shown in FIG. 3b, for US regions, the first three digits of a seven-digit number represent a sub-area code. It should be noted that this rule might be modified or adjusted based on the location of the mobile terminal 100. At block 804, the processor 102 evaluates the location category determined by the location categorization task 600. If the location category is either In_home region or In_neighbor region, then at block 806, the processor 102 determines if the sub-area code is associated with the home area code. In the preferred embodiment of the invention the processor 102 uses the area code table 300, which may be pre-stored in memory 104 to determine if the extracted sub-area code is associated with the home area code or the neighboring area code. At block 806, the processor 102 locates the row of area code table 300, which represents the home area code and searches the column that represents list of sub-area code for the home area code. If the extracted sub-area code is in the list of sub-area code of the home area code, then it is determined that the sub-area is associated with the home area code. Therefore, if determined that the sub-area code is associated to the home area code, then at block 808 the action is to use the dialing sequence without any adjustment. Otherwise, at block 806, if determined that the sub-area code is not associated with the home area code, then at block 810, the processor 102 determines if the sub-area code is associated with the neighboring area code. At block 810, the processor 102 locates all rows representing the neighboring area codes of the home area code and determines if the extracted sub-area code is column that represents the list of sub area codes for each of the neighboring area codes. If yes, then at block 812, the action is to adjust the dialing sequence to add the neighboring area code that is associated with the extracted sub-area code. Otherwise, at block 814, the action is to prompt the user that the dialing sequence was not adjusted. The processor 102 may prompt the user to enter an area code which would be used to adjust the dialing sequence.

Referring back to block 804, if the location category is In_roaming region, then at block 816, the processor 102 determines if the sub-area code is associated with the home area code or one of the neighboring area code using similar techniques described above. At block 816, if determined that the sub-area code is associated with the home area code or one of the neighboring area codes, then at block 818, the processor 102 determines if the sub-area code is associated with only the home area code. At block 818, if the sub-area code is associated with home area code, then at block 820, the action is to add the home area code to the dialing sequence. Otherwise, at 822, the processor 102 generates a list of home-neighboring area codes, which comprise all the area codes considered to be neighboring area codes for the home area code. At 824, the user may be prompted to select a neighboring code, possibly from a list of area codes. At 826, the action is to add the user selected area code to the dialing sequence.

Referring back to block 816, if the sub-area code is not associated with the home area code or one of the neighboring area code, then at block 828, the processor 102 displays a list of options to the user. The list of options comprises an option to use the current area code to adjust the dialing sequence, whereby the action is set to use the current area code to adjust the dialing sequence. The list options further comprises a option to use a user provided area code, whereby the action is to adjust the dialing sequence based on user provided area code. The list of options further comprises an option to generate a neighbor-roaming area code, whereby the action is to generate a list of area codes representing neighboring area codes associated with the roaming region (current region). At block 830, based on the user selects an area code from list which is displayed on the display 110 and based on the user selection, specific action is set for the processor 102 to execute.

As examples, the method and apparatus may also be implemented in electronic devices such as regular PDA, PDA with wireless communication capabilities, general-purpose computers, and devices having a wireless connection or landline connection methods. The method and apparatus may be realized by implementing an operating mode, which may be modified by the user using a menu feature.

Also, as an example, the method may also be processed at the base station 204. Any information provided user at display 110 of the mobile terminal 100 may be transmitted via communication signal 219. Also, any information provided by the user using the input device 120 may be received via communication signal 218 and processed at the base station 204.

Thus, while the invention has been particularly shown and described with respect to preferred embodiments thereof, the above description is intended by way of example only and is not intended to limit the present invention in any way except as set forth in the following claims.

What is claimed is:

1. A method within an electronic device for adjusting a dialing sequence used for initiating a call in a wireless communication system, the electronic device operating in a region, the method comprising the steps of:
evaluating the dialing sequence to determine if the dialing sequence requires any adjustment;
determining a first code of the region based on current location of the electronic device, if determined that the dialing sequence requires any adjustment; and
adjusting the dialing sequence based on said first code of the region.

2. The method as claimed in claim 1, wherein the step of evaluating comprises a step of determining if the dialing sequence represents an emergency number.

3. The method as claimed in claim 2, wherein the step of adjusting comprises a step of using a current location emergency number associated with said first code of the region, if determined that the dialing sequence represents an emergency number.

4. The method as claimed in claim 3, wherein the step of determining first code comprises the step of accessing a database, said first code comprising a country code.

5. The method as claimed in claim 2, wherein said step of determining if the dialing sequence represents an emergency number, comprises a step of determining if the dialing sequence is in a list of emergency numbers, said list of emergency numbers are stored in a database.

6. The method as claimed in claim 1, wherein the step of determining said first code of the region comprises the step of accessing a memory, said memory storing a base station area code and the step of setting said first code to said base station area code.

7. The method as claimed in claim 1, wherein the step of determining said first code of the region comprises the step of determining a position of the electronic device.

8. The method as claimed in claim 7, wherein the step of determining said first code of the region further comprises the step of accessing a database to determine an area code associated with said determined position of the electronic device.

9. The method as claimed in claim 1, wherein the step of evaluating the dialing sequence, comprises the step of determining if a length of the dialing sequence equals to a minimum length required by the region, the region associated with said first area code.

10. The method as claimed in claim 1, wherein the step of evaluating the dialing sequence, comprises the step of determining if a length of the dialing sequence equals to a minimum length required by a home region associated with an assigned home area code of the electronic device.

11. The method as claimed in claim 1, further comprising the step of determining a location category based on said first code of the region and the step of setting said location category to an In_home region category, an In_neighbor region category or an In_roaming region.

12. The method as claimed in claim 11, wherein the step of determining said location category, comprises the step of setting said location category to said In_home region category, if said determine first code equals to a home area code assigned to the electronic device.

13. The method as claimed in claim 11, wherein the step of determining said location category, comprises the step of setting said location category to said In_neighbor region category, if said determine first code equals to a neighbor area code assigned to the electronic device.

14. The method as claimed in claim 11, wherein the step of determining said location category, comprises the step of setting said location category to said In_roaming region category, if said determine first code does not equals to a home area code assigned to the electronic device and a neighbor area code assigned to the electronic device.

15. The method as claimed in claim 1, wherein the step of adjusting comprises the step of adding an area code to the dialing sequence, said area code provided by the user of the electronic device.

16. The method as claimed in claim 15, wherein the step of adding comprises the step of prompting a user to provide said area code.

17. The method as claimed in claim 15, wherein the step of adding comprises the step of prompting a user to select said area code from a plurality of area codes.

18. The method as claimed in claim 15, wherein the step of prompting the user to select, comprises the step of generating said plurality of area codes.

19. The method as claimed in claim 1, wherein the step of adjusting comprises the step of adding a home area code to adjust said dialing sequence.

20. The method as claimed in claim 1, wherein the step of adjusting comprises the step of adding a neighbor area code to adjust said dialing sequence.

21. An electronic device operated in a region, the electronic device receiving a dialing sequence for initiating a call in a wireless communication system, the electronic device comprising:
a processor for evaluating the dialing sequence to determine if the dialing sequence requires any adjustment; said processor further determining a first code of the region based on current location of the electronic device and adjusting the dialing sequence based on said first code of the region if determined that the dialing sequence requires any adjustment.

22. The electronic device as claimed in claim 21, wherein said processor further determines if the dialing sequence represents an emergency number.

23. The electronic device as claimed in claim 22, wherein said processor further uses a current location emergency number associated with said first code of the region, if determined that the dialing sequence represents an emergency number.

24. The electronic device as claimed in claim 23, wherein said processor further accesses a database to determine said first code, said first code comprises a country code.

25. The electronic device as claimed in claim 22, the electronic device further comprising:
a memory coupled said processor, said memory comprising a database;
said database comprising a list of emergency numbers; and
said processor further determines if the dialing sequence is in said list of emergency numbers.

26. The electronic device as claimed in claim 21, wherein said processor further receives a base station area code from a base station and sets said first code to said base station area code.

27.The electronic device as claimed in claim 21, wherein said processor further determines a position of the electronic device.

28.The electronic device as claimed in claim 21, wherein said processor further determines if a length of the dialing sequence equals to a minimum length required by the region associated with said first area code.

29.The electronic device as claimed in claim 21, wherein said processor further determines if a length of the dialing sequence equals to a minimum length required by a home region associated with an assigned home area code of the electronic device.

30. The electronic device as claimed in claim 21, wherein said processor further determines a location category based on said first code of the region, prior to adjusting the dialing sequence.

31. The electronic device as claimed in claim 30, wherein said location category, comprises an In_home region category, an In_neighbor region category and an In_roaming region category.

32. The electronic device as claimed in claim 31, wherein said processor further sets said location category to said In_home region category, if said determine first code equals to a home area code assigned to the electronic device.

33. The electronic device as claimed in claim 31, wherein said processor further sets said location category to said In_neighbor region category, if said determine first code equals to a neighbor area code assigned to the electronic device.

34. The electronic device as claimed in claim 31, wherein said processor further sets said location category to said In roaming region category, if said determine first code does not equals to a home area code assigned to the electronic device and a neighbor area code assigned to the electronic device.

35. The electronic device as claimed in claim 21, further comprising:
an input device coupled to said processor; said input device for receiving an area code from a user of the electronic device; and
said processor further for adding said area code to the dialing sequence.

36. The electronic device as claimed in claim 35, further comprising:
a display coupled to said processor; and
said processor further using said display for prompting the user to provide said area code.

37. The electronic device as claimed in claim 35, further comprising:
a display coupled to said processor; and
said processor further using said display for prompting the user to select said area code from a plurality of area codes.

38. The electronic device as claimed in claim 37, wherein the processor further generates said plurality of area codes and displays said plurality of area codes on said display, prior to prompting the user.

39. The electronic device as claimed in claim 21, wherein the processor further adds a home area code to adjust said dialing sequence.

40. The electronic device as claimed in claim 21, wherein the processor further adds a neighbor area code to adjust said dialing sequence.

41. The electronic device as claimed in claim 21, wherein the processor further stores a home area code, a home country code and a list of neighboring area codes prior to initiating the call.

42. The electronic device as claimed in claim 21, wherein the processor further receives base station information from a base station, said base station information comprises a base station country code and a base station area code, prior to initiating the call.

43. The electronic device as claimed in claim 21, wherein the electronic device comprises a mobile terminal.

44. The electronic device as claimed in claim 21, wherein the electronic device comprises a personal digital assistant.

45. A method within an electronic device for adjusting a dialing sequence used for initiating a call in a wireless communication system, the electronic device operating in a current region defined by current location of the electronic device, the method comprising the steps of:
evaluating the dialing sequence to determine if the dialing sequence is an emergency number;
determining a current location emergency number associated with the current region; and
adjusting the dialing sequence to use said current emergency number if determined that the dialing sequence presents said emergency number.

46. The method as claimed in claim 45, wherein the step of determining, comprises the step of determining a country code and retrieving said current location emergency number associated with said country code of the current region.

47. The method as claimed in claim 46, wherein the step of determining said country code, comprises the step receiving a country code from a base station.

48. The method as claimed in claim 46, wherein the step of determining said country code, comprises the step calculating a position of the electronic device and using the position to determine the country code.

49. The method as claimed in claim 48, wherein the step of determining said country code, comprises the step receiving said country code from an input device of the electronic device.

50. An electronic device operated in a current region based on current location of the electronic device and receiving a dialing sequence for initiating a call in a wireless communication system, the electronic device comprising:
a processor for evaluating the dialing sequence to determine if the dialing sequence is an emergency number; said processor further for determining a current location emergency number associated with the current region and adjusting the dialing sequence to use said current emergency number if determined that the dialing sequence presents said emergency number.

51. The electronic device as claimed in claim 50, wherein the processor further determines a country code and retrieves said current emergency number associated with said country code of the current region to determine said current emergency number.

52. The electronic device as claimed in claim 51, wherein the electronic device comprises a mobile terminal.

53. The electronic device as claimed in claim 51, wherein the electronic device comprises a personal digital assistant.
